(19) United States
(12) Patent Application Publication
(10) Pub. No.: US 2002/0070957 A1
(43) Pub. Date: Jun. 13, 2002

(54) Picture-in-picture with alterable display characteristics

(75) Inventors: Miroslav Trajkovic, Ossining, NY (US); Srinivas Gutta, Buchanan, NY (US); Gregory L. Thorne, Northport, NY (US)

Correspondence Address: Jack E. Haken, c/o U.S. PHILIPS CORPORATION, Intellectual Property Department, 580 White Plains Road, Tarrytown, NY, 10591, US

(73) Assignee: Philips Electronics North America Corporation

(21) Appl. No.: 09/734,778

(22) Filed: Dec. 12, 2000

(51) Int. Cl. G06F 3/14

(52) U.S. Cl. 345/719; 345/768

(57) ABSTRACT

A video display device such as a television having a picture-in-picture (PIP) display and a processor. The processor, in response to user input, alters a display characteristic of the PIP with regard to an underlying video image on a primary display area of the television display. The display characteristic of the PIP that is alterable may be a transparency of the PIP, with regard to the underlying video image, and/or a color bias of the PIP. The processor may alter the display characteristic of the PIP by combining a weighted average of a PIP video image with the underlying video image and/or a color or color scheme. The display characteristic may be further alterable in response to user input by varying a relative weighting of the PIP with regard to the underlying video image and/or the color or color scheme.

### FIELD OF THE INVENTION

This invention generally relates to a method and device to enhance home television usage. Specifically, the present invention relates to a picture-in-picture display that selectively may be set to not obscure a primary display image of a video data stream.

### BACKGROUND OF THE INVENTION

It is very common for televisions to have a capability of displaying more than one video display on the television display at the same time. Typically, the display is separated into two or more portions wherein a main portion of the display is dedicated to a selected video data stream (e.g., a given television channel). A second video data stream is simultaneously shown in a display box that is shown as an inset over the display of the first data stream. This inset box is typically denoted as a picture-in-picture display (“PIP”). This PIP provides the functionality for a television viewer to monitor two or more video data streams at the same time. This may be desirable for instance at a time when a commercial segment has started on a given television channel and a viewer wishes to “surf” additional selected television channels during the commercial segment, yet does not wish to miss the return from the commercial segment. At other times, a viewer may wish to search for other video content or just view the other content without missing content on another selected channel.

In any event, PIP has a problem in that the PIP is typically shown in an inset box that is overlaid on top of a primary display. The overlaid PIP has the undesirable effect of obscuring a portion of the primary display. It is known that the PIP may be automatically repositioned to a portion of the primary display that does not have motion from one frame of the video image to the next, but nonetheless, the PIP will obscure the underlying portion of the primary display. Further, this automatic repositioning of the PIP may be undesirable wherein the user wishes to determine the position or display features of the PIP. Similarly, the PIP may be automatically rendered transparent in response to motion of the underlying primary image. However, this does not provide a user with the flexibility as to whether to render the PIP transparent regardless of the underlying primary display.

It is also known that text or banners may be displayed overlaid on a primary display wherein the banner or text may be displayed transparently. The ability to display the banner transparently is determined by coding placed in the video data stream by the broadcaster. Text may be displayed transparently by inserting the text into the original video signal, and then forming a weighted average of the video signal and the text. However, none of the prior art systems known provide a user with any flexibility in rendering a PIP.

Accordingly, it is an object of the present invention to overcome the disadvantages of the prior art.

### SUMMARY OF THE INVENTION

The present invention is video display device such as a television having a picture-in-picture (PIP) display and a processor. The processor, in response to user input, may alter a display characteristic of the PIP with regard to an underlying video image that is displayed on a primary display area of the television display. The display characteristic of the PIP that is alterable may be a transparency of the PIP, with regard to the underlying video image, and/or a color bias of the PIP.

The processor may alter the display characteristic of the PIP by combining a weighted average of a PIP video image with the underlying video image and/or a color or color scheme. The display characteristic may be further alterable in response to user input by varying a relative weighting of the PIP with regard to the underlying video image and/or the color or color scheme.

### BRIEF DESCRIPTION OF THE DRAWINGS

The following are descriptions of embodiments of the present invention that when taken in conjunction with the following drawings will demonstrate the above noted features and advantages, as well as further ones. It should be expressly understood that the drawings are included for illustrative purposes and do not represent the scope of the present invention. The invention is best understood in conjunction with the accompanying drawings in which:

FIG. 1 shows an illustrative system in accordance with an embodiment of the present invention;

FIG. 2 shows an enlarged view of a display containing illustrative objects in both a PIP and a primary display area in accordance with an embodiment of the present invention; and

FIG. 3 shows a detail of a processor that operates in accordance with an embodiment of the present invention.

### DETAILED DESCRIPTION OF THE INVENTION

In the discussion to follow, certain terms will be illustratively discussed in regard to specific embodiments or systems to facilitate the discussion. However, as would be readily apparent to a person of ordinary skill in the art, these terms should be understood to encompass other similar applications and embodiments wherein the present invention could be readily applied.

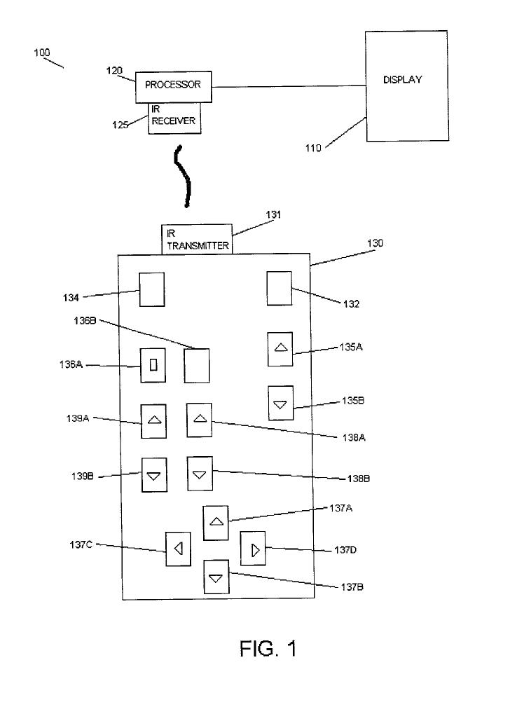

FIG. 1 shows an illustrative system 100 in accordance with an embodiment of the present invention including a display 110, operatively coupled to a processor 120, and a remote control device 130. The processor 120 and the remote control device 130 are operatively coupled as is known in the art via an infrared (IR) receiver 125, operatively coupled to the processor 120, and an IR transmitter 131, operatively coupled to the remote control device 130.

The display 110 may be a television receiver or other device enabled to reproduce audiovisual content for a user to view and listen to. The processor 120 is operable to produce a picture-in-picture display (PIP) on the display 110 as is know by a person of ordinary skill in the art. Further, the processor 120 is operable to provide a PIP display in accordance with the present invention.

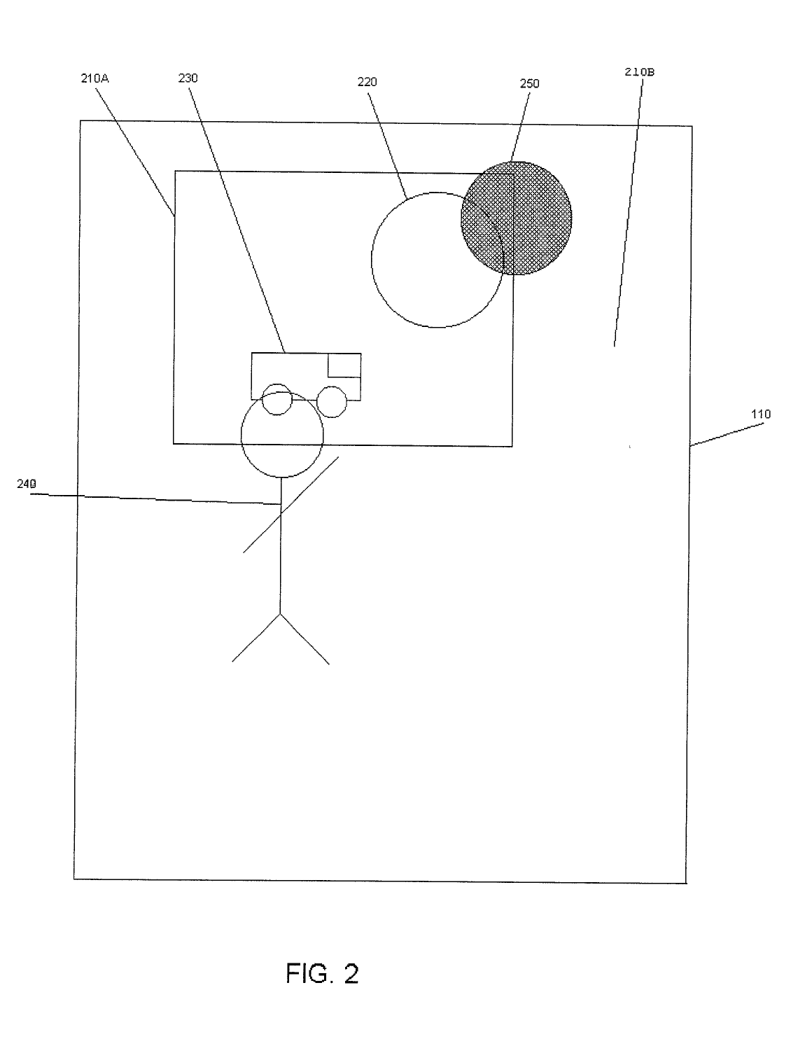

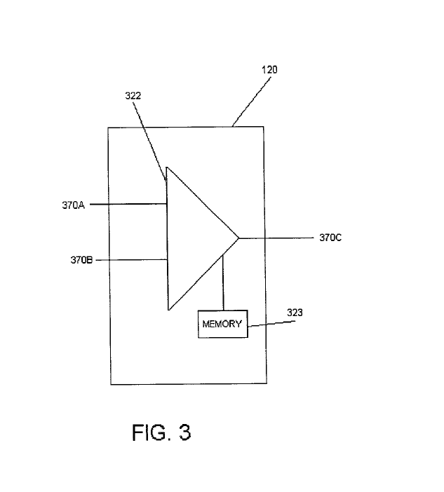

The operation of the illustrative system shown in FIG. 1 will be described herein below with reference to FIGS. 2 and 3. The remote control device 130 contains buttons for operation in accordance with the present invention. Specifically, the remote control device 130 contains a PIP button 134, a swap button 132, a transparent PIP activation button 136A, transparency control buttons 135A, 135B, and PIP position control buttons 137A, 137B, 137C, 137D. The PIP button 134 initiates a PIP function to open a PIP 210A (e.g., see, FIG. 2) on the display 110. The swap button 132 swaps each of the images shown on the PIP 210A portion and on a primary display portion 210B of the display 110. The remote control 130 also may contain other control buttons as is known in the art such as channel selector keys for selecting the video data streams for both the primary display 210B and the PIP 210A.

FIG. 2 shows an enlarged view of the display 110 containing illustrative objects such as a sun object 220 and a truck object 230 in the PIP 210A, and a person object 240 playing with a ball object 250 in the primary display portion 210B. It should be expressly understood that although the present invention is described with regard to objects, a person of ordinary skill in the art would readily appreciate that other picture portions may be rendered within either one or both of the display portions and still be well within the bounds of the present invention.

Specifically, it is known in the art that any given combination of pixel elements from two video data streams may be combined to render an overlaying video data stream (e.g., the PIP 210A video data stream) transparent with regard to the underlying video data stream (e.g., the primary display area 210B video data stream). Accordingly, regardless of the elements present in the PIP 210A and the primary display area 210B, the video data streams from each may be combined to provide a combined video data stream for display on the display 110. The term transparency utilized herein should be understood to refer to the quality of rendering visible a video image that underlies a PIP video image.

FIG. 3 shows a block diagram of a portion of the processor 120 in accordance with an embodiment of the present invention. The processor 120 contains a combining element 322 that receives incoming video data streams 370A, 370B and therefrom, produces a combined video data stream 370C. The video data stream 370A may illustratively be a video data stream selected for display in the PIP 210A utilizing PIP channel selector buttons 138A, 138B on the remote 130. The video data stream 370B may illustratively be a video data stream selected for display in the primary display area 210B utilizing primary display channel selector buttons 139A, 139B on the remote 130. As is apparent to a person of ordinary skill in the art, the PIP channel selector buttons 138A, 138B and the primary display area channel selector buttons 139A, 139B may be combined into one or more sets of buttons for selecting each of the PIP image and the primary display image.

Further, although the buttons 138A, 138B, 139A, 139B are illustratively shown as channel selector buttons, as would be obvious to a person of ordinary skill in the art, the buttons 138A, 138B, 139A, 139B may also select from amongst a plurality of video data streams from one or more other sources of video. For instance, one source of a video data stream may be a broadcast video data stream while another source may be a storage device. The storage device may be a tape storage device (e.g., VHS analog tape), a digital storage device such as a hard drive, an optical storage device, etc., or any other type of know device for storing a video data stream. In fact, any source of a video data stream may be utilized in accordance with the present invention without deviating from the scope of the present invention.

In operation, a user may open the PIP 210A utilizing the PIP button 134. The images from the video data stream 370A shown in the PIP 210A may initially be a standard opaque PIP display as is known in the art. Sometime thereafter, a user may decide for any reason whatsoever, that it is desirable to render the PIP video image transparent with respect to an underlying video image produced from the video data stream 370B. To render the PIP video image transparent, the user may simply depress the transparent PIP button 136A. Further, to render the PIP video image opaque, the user may simply depress the transparent PIP button 136A once again. In accordance with one embodiment of the present invention, the processor may simply render the PIP image at a preset level of transparency with respect to the underlying video image each time a transparent PIP is selected by the user.

In accordance with another embodiment of the present invention, the user may adjust the level of transparency of the PIP video image with respect to the underlying video image by depressing the transparency level control buttons 135A, 135B one or more times. Illustratively, for a combining device 322 that utilizes a weighted average of the incoming video data streams 370A, 370B to produce the combined video data stream 370C, the degree of weighting of one incoming data stream to the other incoming data stream may be varied by the transparency level control buttons 135A, 135B. For example, by the user depressing the transparency level control button 135A, the user may increase the transparency of the PIP video image by increasing the weighting that the video data stream 370B contributes to produce the combined video data stream 370C. As a simple example, the combined video data stream 370C may default to a level wherein the incoming video data streams 370A, 370B are evenly weighted. Increasing the transparency of the PIP video image may result in the incoming video data stream 370B being more heavily weighted (e.g., greater than one times) than the incoming video data stream 370A for producing the combined video data stream 370C. Conversely, the user may decrease the transparency of the PIP video image by the user depressing the transparency level control button 135B. Depression of the transparency level control button 135B may result in the incoming video data stream 370B being weighted less (e.g., less than one times) than the incoming video data stream 370A for producing the combined video data stream 370C. By repeated depression of the transparency level control button 135A, the combined video data stream 370C may be adjusted to contain little or no component of the incoming video data stream 370A. Conversely, by repeated depression of the transparency level control button 135B, the combined video data stream 370C may be adjusted to contain little or no component of the incoming video data stream 370B.

In the same and/or alternate embodiments, a user may desire that a transparent PIP be biased towards a particular underlying color. For example, although the PIP will have a color scheme provided by the video data stream present on the incoming video data stream 370A, a user may desire that the PIP is based towards a pink color or any other color or color scheme for that matter. This bias may facilitate a user to differentiate the transparent PIP image from the underlying image or may just provide a color mood that is desirable.

To produce a transparent PIP having a color bias, a user may depress a color bias button 136B on the remote control device 130 shown in FIG. 1. In operation, the processor 120 may retrieve a color or color scheme from a memory 323 and include the color or color scheme as a portion of the weighted average of the incoming video data streams 370A, 370B that produce the combined video data stream 370C. In one embodiment, the transparency level control buttons 135A, 135B on the remote control device 130 may also vary the degree of bias provided by the underlying color or color scheme. For example, the transparency level control buttons 135A, 135B may operate to adjust the level of bias when depressed together with the color bias button 136B. In addition, the memory 323 may contain one or more colors, color schemes, and/or combinations thereof. For example, the color or color scheme selected from the memory 323 may rotate between all available colors and/or color schemes by repeated depression of the color bias button 136B.

In this or other embodiments in accordance with the present invention, the color biasing of the PIP may operate to render a color biasing to a non-transparent PIP. For example, a user may depress the color bias button 136B without depression of the transparent PIP button 136A. In these embodiments, the color bias button 136B operates similar as described above with the exception that the combined video data stream 370C will contain little or no component from the incoming video data stream 370B. Depression of the color bias button 136B will in this case, produce a weighted average, either fixed or variable, of the incoming video data stream 370A and a selected color or color scheme from the memory 323.

Finally, the above-discussion is intended to be merely illustrative of the present invention. Numerous alternative embodiments may be devised by those having ordinary skill in the art without departing from the spirit and scope of the following claims. For example, although the processor 120 is shown separate from the display 110, clearly both may be combined in a single display device such as a television. In addition, the processor may be a dedicated processor for performing in accordance with the present invention or may be a general purpose processor wherein only one of many functions operate for performing in accordance with the present invention. In addition, the processor may operate utilizing a program portion or may be a hardware device utilizing a dedicated or multi-purpose integrated circuit. In addition, although the PIP is illustratively described above as being rendered transparent, or color biased with regard to an underlying image, these are only some display characteristics of the PIP that may be altered in accordance with the present invention. Also, although the above invention is described above with regard to a PIP on a television display, the present invention may be suitably utilized with any display device that has the ability to display a primary image and a PIP including a computer monitor or any other known display device.

The claimed invention is:

1. A video display device comprising:
a display configured to display a primary image and a picture-in-picture image (PIP) overlaying the primary image;
a processor operatively coupled to the display and configured to receive a first video data stream for the primary image and to receive a second video data stream for the PIP; and
a user input device operatively coupled to the processor and configured to alter a display characteristic of the PIP with respect to the primary image.

2. The video display device of claim 1, wherein the display characteristic of the PIP is a transparency of the PIP and the processor is configured to alter the transparency of the PIP with respect to the primary image.

3. The video display device of claim 2, wherein the processor is configured to render the PIP transparent by combining a weighted average of the first and second video data streams.

4. The video display device of claim 3, wherein the user input device is configured to provide a signal to the processor to adjust the weighted average in response to a user input.

5. The video display device of claim 1, wherein the display characteristic of the PIP is a color bias of the PIP and the processor is configured to alter the color bias of the PIP with respect to the primary image.

6. The video display device of claim 5, wherein the processor is configured to alter the color bias of the PIP by combining a weighted average of the first video data stream and a color bias.

7. The video display device of claim 6, wherein the user input device is configured to provide a signal to the processor to adjust the color bias of the PIP by adjusting the weighted average in response to a user input.

8. The video display device of claim 6, wherein the color bias is one of a solid color bias or a color scheme.

9. The video display device of claim 1, wherein the video display device is a television.

10. A television comprising:
a display configured to display a primary image and a picture-in-picture image (PIP) overlaying the primary image;
a processor operatively coupled to the display and configured to receive a first video data stream for the primary image and to receive a second video data stream for the PIP; and
a user input device operatively coupled to the processor and configured to render the PIP transparent with respect to the primary image.

11. The television of claim 10, wherein the processor is configured to render the PIP transparent by combining a weighted average of the first and second video data streams.

12. The television of claim 10, wherein the processor is configured to render the PIP transparent by combining a weighted average of the first and second video data streams and the user input device is configured to provide a signal to the processor to adjust the weighted average in response to a user input.

13. The television of claim 10, wherein the processor is configured to bias the PIP with one of a color or a color scheme.

14. The television of claim 13, wherein the user input device is configured to provide a signal to the processor to alter the color bias of the PIP in response to a user input.
